(19) United States
(12) Patent Application Publication
(10) Pub. No.: US 2023/0357465 A1
(43) Pub. Date: Nov. 9, 2023

(54) POLYETHYLENE-BASED-RESIN COMPOSITION AND POLYETHYLENE-BASED-RESIN PACKAGING MATERIAL

(71) Applicant: SANIPAK COMPANY OF JAPAN, LTD., Tokyo (JP)

(72) Inventors: Yoshihiro HORIGOME, Tokyo (JP); Manabu OSAKI, Tokyo (JP); Keisuke YAMAMOTO, Tokyo (JP); Yasuhiro NAKAGAWA, Tokyo (JP)

(21) Appl. No.: 18/026,070

(22) PCT Filed: Sep. 16, 2020
(86) PCT No.: PCT/JP2020/035049

§ 371 Date: Mar. 13, 2023

(51) Int. Cl. C08F 210/16; C08K 3/26; B29C 48/00

(52) U.S. Cl. CPC C08F 210/16; C08K 3/26; B29C 48/022; C08K 2003/265; B29K 2023/065

(57) ABSTRACT

An object of the present invention is to provide a polyethylene-based-resin composition from which a film can be obtained which has excellent moldability even in a case where an inorganic compound is added, and has excellent bag-making processability and film strength; and a polyethylene-based-resin packaging material formed of the polyethylene-based-resin composition. In a polyethylene-based-resin composition containing an inorganic compound and an ethylene-α-olefin copolymer, at least a part of the ethylene-α-olefin copolymer is an ethylene-α-olefin copolymer A in which α-olefin has 6 to 8 carbon atoms and a melt flow rate is 0.8 g/10 min or more and 4.0 g/10 min or less, the amount of the inorganic compound is 50% by mass or more and 80% by mass or less, and the amount of the ethylene-α-olefin copolymer A is 10% by mass or more and 50% by mass or less.

### TECHNICAL FIELD

The present invention relates to a polyethylene-based-resin composition and a polyethylene-based-resin packaging material.

### BACKGROUND ART

A polyethylene-based-resin packaging material has been used in many applications including garbage bags, shopping bags, and fashion bags. In recent years, with global warming, there is a strong demand to reduce the amount of carbon dioxide generated, and it is important to suppress the amount of resin used. As a method for reducing the amount of resin used, a method of adding an inorganic compound to the resin while ensuring moldability has been known. Patent Documents 1 and 2 disclose adding calcium carbonate to the resin.

### CITATION LIST

### Patent Documents

### Patent Document 1

Japanese Patent No. 3366942

### Patent Document 2

Japanese Unexamined Patent Application, First Publication No. 2018-21121

### SUMMARY OF INVENTION

### Technical Problem

However, the films containing calcium carbonate of Patent Document 1 and Patent Document 2 are inferior in bag-making processability or film strength by heat sealing.

An object of the present invention is to provide a polyethylene-based-resin composition from which a film can be obtained which has excellent moldability even in a case where an inorganic compound is added, and has excellent bag-making processability and film strength; and a polyethylene-based-resin packaging material formed of the polyethylene-based-resin composition.

### Solution to Problem

The present inventors have found that, by using an ethylene-α-olefin copolymer which has a melt flow rate in a specific range and in which the number of carbon atoms in α-olefin is 6 to 8, it is possible to obtain a polyethylene-based-resin packaging material in which excellent moldability and bag-making processability are ensured even in a case where an inorganic compound is contained, and which has excellent film strength.

The present invention has the following aspects.
[1] A polyethylene-based-resin composition containing an inorganic compound and an ethylene-α-olefin copolymer, in which at least a part of the ethylene-α-olefin copolymer is an ethylene-α-olefin copolymer A in which α-olefin has 6 to 8 carbon atoms and a melt flow rate is 0.8 g/10 min or more and 4.0 g/10 min or less, an amount of the inorganic compound is 50% by mass or more and 80% by mass or less with respect to a total mass of the resin composition, and an amount of the ethylene-α-olefin copolymer A is 10% by mass or more and 50% by mass or less with respect to the total mass of the resin composition.
[2] The polyethylene-based-resin composition according to [1], in which the ethylene-α-olefin copolymer A has a melting point of 90° C. or higher and 130° C. or lower.
[3] The polyethylene-based-resin composition according to [1] or [2], in which the inorganic compound is calcium carbonate.
[4] A polyethylene-based-resin packaging material formed from the polyethylene-based-resin composition according to any one of [1] to [3].
[5] The polyethylene-based-resin packaging material according to [4], in which the polyethylene-based-resin packaging material is for a garbage bag, a shopping bag, a fashion bag, a storage bag, or a packing bag.

### Advantageous Effects of Invention

According to the present invention, it is possible to provide a polyethylene-based-resin composition from which a film can be obtained which has excellent moldability even in a case where an inorganic compound is added, and has excellent bag-making processability and film strength; and a polyethylene-based-resin packaging material formed of the polyethylene-based-resin composition.

### DESCRIPTION OF EMBODIMENTS

[Polyethylene-Based-Resin Composition]

The polyethylene-based-resin composition (hereinafter, referred to as “PE-based-resin composition”) according to the embodiment of the present invention contains an inorganic compound and an ethylene-α-olefin copolymer.

The ethylene-α-olefin copolymer is a copolymer obtained by a copolymerization using ethylene and α-olefin, and is preferably linear low density polyethylene (LLDPE). At least a part of the ethylene-α-olefin copolymer contained in the PE-based-resin composition according to the embodiment of the present invention is an ethylene-α-olefin copolymer A (hereinafter, referred to as “copolymer A”) in which α-olefin has 6 to 8 carbon atoms and a melt flow rate (MFR) is 0.8 g/10 min or more and 4.0 g/10 min or less.

The number of carbon atoms in α-olefin used in the copolymer A is 6 or more and 8 or less. As the α-olefin used in the copolymer A, specifically, 1-hexene and 1-octene are exemplary examples. The α-olefin used in the copolymer A may be of one type, or two or more types.

The MFR of the copolymer A is 0.8 g/10 min or more and 4.0 g/10 min or less, preferably 0.8 g/10 min or more and 2.0 g/10 min or less, more preferably 0.8 g/10 min or more and 1.5 g/10 min or less, and still more preferably 0.8 g/10 min or more and 1.2 g/10 min or less. In a case where the MFR of the copolymer A is equal to or more than the lower limit value of the above-described range, excellent moldability can be ensured even at a low molding temperature, so that deterioration of the copolymer A can be suppressed. In a case where the MFR of the copolymer A is equal to or less than the upper limit value of the above-described range, melt tension is not too low, so that molding of the film is easier.

The MFR is a value obtained by applying a load of 2.16 kg to a resin (polymer) heated to 190° C. and measuring the amount of resin flowing out from an orifice with a diameter of 2.09 mm in 10 min.

A melting point of the copolymer A is preferably 90° C. or higher and 130° C. or lower, and more preferably 100° C. or higher and 125° C. or lower. In a case where the melting point of the copolymer A is equal to or more than the lower limit value of the above-described range, the shape of heat-sealed bag is good. In a case where the melting point of the copolymer A is equal to or less than the upper limit value of the above-described range, the heat-sealing time can be shortened, and bag-making speed (production speed) is improved.

The melting point is a temperature corresponding to a melting peak measured by differential scanning calorimetry (DSC).

As the copolymer A, among LLDPE in which the number of carbon atoms in α-olefin is 6 (C6-LLDPE) and LLDPE in which the number of carbon atoms in α-olefin is 8 (C8-LLDPE), copolymers having an MFR satisfying the above-described range are exemplary examples.

The copolymer A contained in the PE-based-resin composition may be of one type, or two or more types.

A method for producing the copolymer A is not particularly limited, and a polymerization using a Ziegler-type catalyst mainly composed of a transition metal such as titanium, a polymerization using a Phillips-type catalyst based on a chromium-based catalyst, and a polymerization using a Kaminsky-type catalyst based on a metallocene-based catalyst are exemplary examples. As the polymerization method, any of a solution polymerization method, a slurry polymerization method, a gas phase polymerization method, or a high-pressure ion polymerization method may be used. In addition, the polymerization may be a one-stage polymerization or a multi-stage polymerization of two or more stages.

The PE-based-resin composition according to the embodiment of the present invention may contain an ethylene-α-olefin copolymer other than the copolymer A. Other ethylene-α-olefin copolymers are not particularly limited, and ethylene-α-olefin copolymers in which the number of carbon atoms in α-olefin is 4 are exemplary examples. Among these, LLDPE in which the number of carbon atoms in α-olefin is 4 (C4-LLDPE) is preferable. The ethylene-α-olefin copolymer other than the copolymer A, contained in the PE-based-resin composition, may be of one type, or two or more types.

As long as it does not impair the effects of the present invention, the PE-based-resin composition according to the embodiment of the present invention may include a high-density polyethylene (HDPE), a low-density polyethylene (LDPE), an ultra-low-density polyethylene (VLDPE), an ethylene-vinyl acetate resin (EVA), an ethylene-vinyl alcohol copolymer (EVOH), an ethylene-propylene copolymer, or the like, in addition to the copolymer A.

As the resin component contained in the PE-based-resin composition according to the embodiment of the present invention, the copolymer A alone, a combination of the copolymer A and C4-LLDPE, a combination of the copolymer A and HDPE, or a combination of the copolymer A, C4-LLDPE, and HDPE is preferable.

The amount of the copolymer A in the PE-based-resin composition is 10% by mass or more and 50% by mass or less with respect to the total mass of the P-based-resin composition, preferably 13% by mass or more and 50% by mass or less, and more preferably 16% by mass or more and 50% by mass or less. In a case where the amount of the copolymer A is equal to or more than the lower limit value of the above-described range, sufficient film strength is obtained. In a case where the amount of the copolymer A is equal to or less than the upper limit value of the above-described range, the effect of suppressing the amount of resin used is sufficiently obtained.

In a case where the PE-based-resin composition according to the embodiment of the present invention contains C4-LLDPE, the amount of C4-LLDPE in the PE-based-resin composition is preferably 10% by mass or more and 40% by mass or less, and more preferably 20% by mass or more and 40% by mass or less with respect to the total mass of the PE-based-resin composition. In a case where the amount of C4-LLDPE is equal to or more than the lower limit value of the above-described range, stable moldability is obtained. In a case where the amount of C4-LLDPE is equal to or less than the upper limit value of the above-described range, the effect of suppressing the amount of resin used is sufficiently obtained.

In a case where the PE-based-resin composition according to the embodiment of the present invention contains HDPE, the amount of HDPE in the PE-based-resin composition is preferably 5% by mass or more and 20% by mass or less, and more preferably 5% by mass or more and 15% by mass or less with respect to the total mass of the PE-based-resin composition. In a case where the amount of HDPE is equal to or more than the lower limit value of the above-described range, bag-making properties of the film are stabilized. In a case where the amount of HDPE is equal to or less than the upper limit value of the above-described range, the effect of suppressing the amount of resin used is sufficiently obtained.

The amount of all resin components in the PE-based-resin composition is preferably 20% by mass or more and 50% by mass or less, more preferably 25% by mass or more and 50% by mass or less, and still more preferably 30% by mass or more and 50% by mass or less with respect to the total mass of the PE-based-resin composition. In a case where the amount of all resin components is equal to or more than the lower limit value of the above-described range, sufficient film strength is likely to be obtained. In a case where the amount of all resin components is equal to or less than the upper limit value of the above-described range, the effect of suppressing the amount of resin used is sufficiently obtained.

The inorganic compound contained in the PE-based-resin composition is not particularly limited, and calcium carbonate, titanium oxide, silica, clay, talc, kaolin, and aluminum hydroxide are exemplary examples. Among these, calcium carbonate is preferable. The inorganic compound may be used alone, or in combination of two or more kinds thereof.

The calcium carbonate may be so-called heavy calcium carbonate obtained by mechanically pulverizing limestone, or so-called precipitated calcium carbonate obtained by a carbonation method. The calcium carbonate may be surface-treated, or may not be surface-treated. The calcium carbonate may be used alone, or in combination of two or more kinds thereof.

An average particle size of the calcium carbonate is preferably 5.0 μm or less, and more preferably 3.0 μm or less. In a case where the average particle size of the calcium carbonate is equal to or less than the upper limit value of the above-described range, excellent moldability can be ensured, and defects such as aggregation, holes caused by the size of the particles themselves, and poor appearance are less likely to occur during film molding. The lower limit of the average particle size of the calcium carbonate is preferably 0.1 μm. The average particle size of the calcium carbonate is preferably 0.1 μm or more and 5.0 μm or less. The average particle size of the calcium carbonate is measured by an air permeation method.

A top-cut particle size of the calcium carbonate is preferably 15 μm or less, and more preferably 10 μm or less. The top-cut particle size is measured with an X-ray transmission particle size distribution analyzer.

A 45 μm-sieve residue of the calcium carbonate is preferably 0.01% by mass or less. The 45 μm-sieve residue is measured using a JIS standard sieve.

The amount of the inorganic compound in the PE-based-resin composition according to the embodiment of the present invention is 50% by mass or more and 80% by mass or less with respect to the total mass of the resin composition, preferably 50% by mass or more and 75% by mass or less, and more preferably 50% by mass or more and 70% by mass or less. In a case where the amount of the inorganic compound is equal to or more than the lower limit value of the above-described range, the effect of suppressing the amount of resin used is sufficiently obtained. In a case where the amount of the inorganic compound is equal to or less than the upper limit value of the above-described range, sufficient film strength is obtained.

The PE-based-resin composition according to the embodiment of the present invention may contain an additive as necessary. As the additive, an antioxidant, a light stabilizer, a lubricant, a dispersant, a pigment, an antistatic agent, and an animal repellent are exemplary examples. The additive may be of one kind, or two or more kinds.

The amount of the additive in the PE-based-resin composition according to the embodiment of the present invention is preferably 3% by mass or less, and more preferably 1% by mass or less with respect to the total mass of the PE-based-resin composition.

A method for producing the PE-based-resin composition according to the embodiment of the present invention is not particularly limited, and methods of mixing each component with a single-screw extruder, a multi-screw extruder, a Banbury mixer, a kneader, or the like are exemplary examples. Apart of the copolymer A and the resin component other than the copolymer A, used as necessary, may be mixed in advance with the inorganic compound or the additive to prepare a masterbatch, and the masterbatch and the rest of the resin component may be mixed.

The mixing temperature during production of the PE-based-resin composition can be adjusted as appropriate, for example, 150° C. or higher and 190° C. or lower.

[Polyethylene-Based-Resin Packaging Material]

The polyethylene-based-resin packaging material (hereinafter, referred to as “PE-based-resin packaging material”) according to the embodiment of the present invention is a packaging material formed from the PE-based-resin composition according to the embodiment of the present invention. As aspects of the P-based-resin packaging material according to the embodiment of the present invention, known aspects can be adopted except that the PE-based-resin composition according to the embodiment of the present invention is used.

Applications of the PE-based-resin packaging material are not particularly limited, and a garbage bag, a shopping bag, a fashion bag, a storage bag, and a packing bag are exemplary examples.

As a method for producing the PE-based-resin packaging material according to the embodiment of the present invention, a known method can be adopted except that the PE-based-resin composition according to the embodiment of the present invention is used. A method of molding the PE-based-resin composition according to the embodiment of the present invention into a film, and heat-sealing the film to make a bag is an exemplary example. As the method of molding into a film, inflation molding and T-die extrusion molding are exemplary examples.

The molding temperature (extrusion temperature) can be adjusted as appropriate, for example, 150° C. or higher and 190° C. or lower.

The thickness of the film may be appropriately set according to the application, and can be, for example, 10 μm or more and 70 μm or less.

As described above, in the present invention, the PE-based-resin composition contains the specific copolymer A in a specific ratio. As a result, excellent moldability can be ensured even in a case where the amount of the inorganic compound is high, and a film excellent in bag-making processability and film strength is obtained. In addition, the PE-based-resin packaging material obtained by using the PE-based-resin composition according to the embodiment of the present invention can be produced with high productivity, and can withstand packaging and transportation of heavy objects.

Hereinafter, the present invention will be described in detail with reference to Examples, but the present invention is not limited to the following description.

### Abbreviation

The following abbreviations have the following meanings.

(Copolymer A)

A-1: C6-LLDPE, trade name “Novatec SF720”, manufactured by Japan Polyethylene Corporation, MFR: 0.8 g/10 min, melting point: 124° C.

A-2: C6-LLDPE, trade name “Harmolex NC564A”, manufactured by Japan Polyethylene Corporation. MFR: 3.5 g/10 min, melting point: 124° C.

A-3: C6-LLDPE, trade name “D139FK”, manufactured by Chevron Phillips Chemical Company LLC., MFR: 1.0 g/10 min, melting point: 90° C.

A-4: C6-LLDPE, trade name “Evolue (registered trademark) 2320”, manufactured by Prime Polymer Co., Ltd., MFR: 1.8 g/10 min, melting point: 118° C.

A-5: C8-LLDPE, trade name “Moretec (registered trademark) 0168N”, manufactured by Prime Polymer Co., Ltd., MFR: 1.2 g/10 min, melting point: 125° C.

A-6: C8-LLDPE, trade name “0138NK”, manufactured by Prime Polymer Co., Ltd., MFR: 1.5 g/10 min, melting point: 117° C.

(Other Polymer B)

B-1: C4-LLDPE, trade name “FS153S”, manufactured by Sumitomo Chemical Asia Pte Ltd.

B-2: C6-LLDPE, trade name “TZ050”, manufactured by TOSOH CORPORATION, MFR: 0.5 g/10 min, melting point: 119° C.

B-3: C6-LLDPE, trade name “Harmolex NH645A”, manufactured by Japan Polyethylene Corporation, MFR: 8.0 g/10 min, melting point: 121° C.

B-4: HDPE, trade name “FJ00952”, manufactured by SABIC

### Production Example 1

80% by mass of calcium carbonate (Lighton BS-0, average particle size: 1.0 μm, manufactured by BIHOKU FUNKA KOGYO CO., LTD.) and 20% by mass of pellets of the copolymer A-5 (C8-LLDPE) were mixed in a super mixer for 5 minutes, the mixture was extruded into strands with a twin-screw extruder, and the strands were cut into pellets to obtain a masterbatch (MB-1).

### Production Example 2

A masterbatch (MB-2) was obtained in the same manner as in Production Example 1, except that the copolymer A-4 (C6-LLDPE) was used instead of the copolymer A-5.

### Production Example 3

A masterbatch (MB-3) was obtained in the same manner as in Production Example 1, except that the polymer B-1 (C4-LLDPE) was used instead of the copolymer A-5.

### Example 1

As an inflation molding machine, an extruder (manufactured by Placo Co., Ltd.) having a cylinder inner diameter of 55 mm and a screw L/D of 32, and an annular die having a die diameter of 100 mmφ and a lip of 3 mm were used.

Each of raw materials was weighed so that MB-1 was 65% by mass and the polymer B-1 (C4-LLDPE) was 35% by mass and fed into the extruder to prepare a PE-based-resin composition, and a tubular film having a thickness of 30 μm and a folding width of 460 mm was molded by inflation molding. The extrusion temperature was 170° C., and the blow ratio was approximately 3.0. Next, the film was heat-sealed at intervals of 600 mm in a longitudinal direction by a bag-making machine (manufactured by Nozaki Kogyo Co., Ltd.), and was cut to produce a bag. The heat-sealing temperature was 160° C. or higher and 180° C. or lower.

The amount of calcium carbonate in the film (PE-based-resin composition) was 52% by mass, and the amount of the copolymer A was 13% by mass.

### Examples 2 to 61

Bags were produced in the same manner as in Example 1, except that the composition of the PE-based-resin composition was changed as shown in Table 1.

### Examples 7 to 10

Bags were produced in the same manner as in Example 1, except that the composition of the PE-based-resin composition was changed as shown in Table 1 and the thickness of the film was 20 μm.

### Comparative Examples 1 to 51

Bags were produced in the same manner as in Example 1, except that the composition of the PE-based-resin composition was changed as shown in Table 2.

[Film moldability]

The stability of the tube during film molding of each example was confirmed, and the moldability was evaluated according to the following standard.
“1”: more stable than normal resin (containing no inorganic compound)
“2”: stable like normal resin
“3”: slightly more unstable than normal resin, but capable of being continuously molded
“4”: unstable and not capable of being molded

[Bag-Making Processability]

The production speed during bag making and the finished shape of the sealed portion were confirmed, and the moldability was evaluated according to the following standard.
“1”: the production speed and the finish of the sealed portion were improved as compared with a case without the inorganic substance.
“2”: the production speed and the finish of the sealed portion were equivalent to a case without the inorganic substance.
“3”: the finish of the seal shape was poor as compared with a case without the inorganic substance.
“4”: the production speed was very inferior to a case without the inorganic substance.

[Film Strength]

The film molded in each example was pierced with a thumb, and the spread of the tear was observed in a case where force was applied to the pierced hole, and the film strength was evaluated according to the following standard.

(Evaluation Standard)
“1”: the film could not be easily pierced.
“2”: the tear did not spread from the pierced hole.
“3”: the tear spread from the pierced hole.
“4”: a finger could be easily pierced.

Tables 1 and 2 show the composition of the PE-based-resin composition, the thickness of the film, and the evaluation results of each example.
In Tables 1 and 2, “LLDPE (C6 to C8)” indicates LLDPE in which the number of carbon atoms in α-olefin was 6 to 8. “CaCos₃ content” indicates the amount of calcium carbonate in the PE-based-resin composition (film). “LLDPE (C6 to C8) content” indicates the total amount of LLDPE in which the number of carbon atoms in α-olefin in the PE-based-resin composition (film) was 6 to 8. “Copolymer A content” indicates the amount of the copolymer A in the PE-based-resin composition (film). “1.0, 1.2” in the column of MFR indicates that LLDPE having an MFR of 1.0 g/10 min and LLDPE having an MFR of 1.2 g/10 min were used in combination, and the same applies to other columns. “90, 118” in the column of melting point indicates that LLDPE having a melting point of 90° C. and LLDPE having a melting point of 118° C. were used in combination, and the same applies to other columns.

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Copolymer | A-1 (C6-LLDPE) | | | | | 35 | | | | | |
| A | A-2 (C6-LLDPE) | | | | 20 | | | | | | |
| | A-3 (C6-LLDPE) | | 25 | | | | | 10 | 10 | 25 | 30 |
| | A-6 (C8-LLDPE) | | | 15 | | | | | | | |
| Other | B-1 (C4-LLDPE) | 35 | 10 | | | | 20 | 25 | 20 | | |
| polymer | B-2 (C6-LLDPE) | | | | | | | | | | |
| | B-3(C6-LLDPE) | | | | | | | | | | |
| | B-4 (HDPE) | | | 20 | 15 | | | | 5 | 10 | 5 |
| Masterbatch | MB-1 (A-5 (C8-LLDPE): | 65 | | | 65 | 65 | | 65 | 65 | 65 | 65 |
| | 20 wt %) | | | | | | | | | | |
| | MB-2 (A-4 (C6-LLDPE): | | 65 | 65 | | | 80 | | | | |
| | 20 wt %) | | | | | | | | | | |
| | MB-3 (B-1 (C4-LLDPE): | | | | | | | | | | |
| | 20 wt %) | | | | | | | | | | |

| | | | | | | | | | | |
|---|---|---|---|---|---|---|---|---|---|---|
| MFR of LLDPE (C6 to C8) | 1.2 | 1.0, | 1.2, | 1.8, | 0.8, | 1.8 | 1.0, | 1.0, | 1.0, | 1.0, |
| [10 g/min] | | 1.2 | 1.5 | 3.5 | 1.2 | | 1.2 | 1.2 | 1.2 | 1.2 |
| Melting point of LLDPE | 125 | 90, | 117, | 124, | 124, | 127 | 90, | 90, | 90, | 90, |
| (C6 to C8) [° C.] | | 118 | 118 | 125 | 125 | | 125 | 125 | 125 | 125 |
| CaCO₃ content [% by mass] | 52 | 52 | 52 | 52 | 52 | 64 | 52 | 52 | 52 | 52 |
| LLDPE (C6 to C8) content [% by mass] | 13 | 38 | 28 | 38 | 48 | 16 | 25 | 25 | 38 | 43 |
| Copolymer A content [% by mass] | 13 | 38 | 28 | 38 | 48 | 16 | 25 | 25 | 38 | 43 |
| Film thickness [μm] | 30 | 30 | 30 | 30 | 30 | 30 | 20 | 20 | 20 | 20 |
| Film moldability | 2 | 2 | 2 | 2 | 2 | 2 | 2 | 1 | 1 | 1 |
| Bag-making processability | 2 | 2 | 2 | 2 | 2 | 2 | 2 | 1 | 1 | 1 |
| Film strength | 2 | 2 | 2 | 2 | 2 | 2 | 1 | 2 | 2 | 2 |

TABLE 2

| | | Comparative Example | | | | |
|---|---|---|---|---|---|---|
| | | 1 | 2 | 3 | 4 | 5 |
| Copolymer A | A-1 (C6-LLDPE) | | | | | |
| | A-2 (C6-LLDPE) | | | | | |
| | A-3 (C6-LLDPE) | | | | | |
| | A-6 (C8-LLDPE) | | | | | |
| Other polymer | B-1 (C4-LLDPE) | 35 | | | | 35 |
| | B-2 (C6-LLDPE) | | | | 35 | |
| | B-3 (C6-LLDPE) | | | 35 | | |
| | B-4 (HDPE) | | 20 | | | |
| Masterbatch | MB-1 (A-5 (C8-LLDPE): 20 wt %) | | | | | |
| | MB-2 (A-4 (C6-LLDPE): 20 wt %) | | | | | 30 |
| | MB-3 (B-1 (C4-LLDPE): 20 wt %) | 65 | 80 | 65 | 65 | 35 |

| | | | | | |
|---|---|---|---|---|---|
| MFR of LLDPE (C6 to C8) [10 g/min] | — | — | 8.0 | 0.5 | 1.8 |
| Melting point of LLDPE (C6 to C8) [° C.] | — | — | 121 | 119 | 127 |
| CaCO₃ content [% by mass] | 52 | 64 | 52 | 52 | 52 |
| LLDPE (C6 to C8) content [% by mass] | 0 | 0 | 35 | 35 | 6 |
| Copolymer A content [% by mass] | 0 | 0 | 0 | 0 | 6 |
| Film thickness [μm] | 30 | 30 | 30 | 30 | 30 |
| Film moldability | 2 | 2 | 4 | 3 | 2 |
| Bag-making processability | 2 | 2 | 4 | 3 | 2 |
| Film strength | 4 | 4 | 4 | 4 | 3 |

As shown in Tables 1 and 2, in Examples 1 to 10 in which the PE-based-resin composition contained the copolymer A in a specific ratio, the film moldability, the bag-making processability, and the film strength were all excellent.

On the other hand, in Comparative Examples 1 to 4 in which the PE-based-resin composition did not contain the copolymer A, and in Comparative Example 5 in which the amount of the copolymer A in the PE-based-resin composition was small, one or more of the film moldability, the bag-making processability, and the film strength was inferior.

1. A polyethylene-based-resin composition comprising:
an inorganic compound;
an ethylene-α-olefin copolymer;
a high-density polyethylene,
wherein at least a part of the ethylene-α-olefin copolymer is an ethylene-α-olefin copolymer A in which α-olefin has 6 to 8 carbon atoms and a melt flow rate is 1.0 g/10 min or more and 2.0 g/10 min or less,
an amount of the inorganic compound is 50% by mass or more and 80% by mass or less with respect to a total mass of the resin composition,
an amount of the ethylene-α-olefin copolymer A is 10% by mass or more and 50% by mass or less with respect to the total mass of the resin composition, and
an amount of the high-density polyethylene is 5% by mass or more and 15% by mass or less with respect to the total mass of the resin composition.

2. The polyethylene-based-resin composition according to claim 1,
wherein the ethylene-α-olefin copolymer A has a melting point of 90° C. or higher and 130° C. or lower.

3. The polyethylene-based-resin composition according to claim 1, wherein the inorganic compound is calcium carbonate.

4. A polyethylene-based-resin packaging material formed from the polyethylene-based-resin composition according to claim 1.

5. The polyethylene-based-resin packaging material according to claim 4, wherein the polyethylene-based-resin packaging material is for a garbage bag, a shopping bag, a fashion bag, a storage bag, or a packing bag.
